(19) United States
(12) Patent Application Publication
(10) Pub. No.: US 2009/0276575 A1
(43) Pub. Date: Nov. 5, 2009

(54) INFORMATION PROCESSING APPARATUS AND COMPILING METHOD

(75) Inventors: Yoriharu Takai, Kodaira-shi (JP); Kenji Yoshida, Akishima-shi (JP)

Correspondence Address: KNOBBE MARTENS OLSON & BEAR LLP, 2040 MAIN STREET, FOURTEENTH FLOOR, IRVINE, CA, 92614, US

(73) Assignee: Kabushiki Kaisha Toshiba, Tokyo (JP)

(21) Appl. No.: 12/420,709

(22) Filed: Apr. 8, 2009

(30) Foreign Application Priority Data
Apr. 30, 2008 (JP) 2008-119299

(51) Int. Cl. G06F 12/08

(52) U.S. Cl. 711/118; 711/E12.052

(57) ABSTRACT

According to one embodiment, an information processing apparatus includes a processor, a cache, and a cache controller. The processor is configured to output a memory access request for accessing an entity of a variable stored in a variable-storage region provided in a memory by using first or second memory address. Both the first and second memory addresses are allocated to the variable-storage region. The cache is configured to store some of data items stored in the memory. The cache controller is configured to access the memory or the cache by using a memory address designating the variable-storage region, in accordance with one of the first and second memory addresses which is included in a memory access request coming from the processor.

### CROSS-REFERENCE TO RELATED APPLICATIONS

This application is based upon and claims the benefit of priority from Japanese Patent Application No. 2008-119299, filed Apr. 30, 2008, the entire contents of which are incorporated herein by reference.

### BACKGROUND

1. Field

One embodiment of the invention relates to an information processing apparatus that includes a cache and also to a compile method of generating a program for use in the information processing apparatus.

2. Description of the Related Art

Various information processing apparatuses, such as personal computers, personal digital assistants (PDAs) and embedded systems, have been developed in recent years.

Such an information processing apparatus usually incorporates a cache in order to prevent a decrease of processing ability, which may result from the latency for accessing a memory such as dynamic RAM. The cache may hold data such as variables that the processor has requested for. In this case, the data can be instantaneously read from the cache and can be supplied to the processor.

In most cases, whether the variables managed by a program can be cache-controlled is uniquely determined in accordance with whether the memory region in which the variables are held is a cacheable region or a non-cacheable region. To change dynamically the setting of a cacheable region or a non-cacheable region, access must be made to the cache control register that controls the cache. In this case, however, the code for achieving an access to the cache control register must be described in the program.

Jpn. Pat. Appln. KOKAI Publication No. 10-78916 discloses a computer system in which the cache mode is designated for a specified memory region that may be accessed by a peripheral control unit while the non-cache mode is designated for any other memory regions. In this system, prescribed upper-bit addresses are used to designate the non-cache mode, and other upper-bit addresses are used to designate the cache mode.

In the system disclosed in Jpn. Pat. Appln. KOKAI Publication No. 10-78916, however, no measures are taken to select cache control or cache non-control for the same data stored in the memory. That is, in this system, the data that can be used by a peripheral control unit is accessed only while the cache control remains prohibited. Thus, in order to access the data, the processor needs to access the memory. This inevitably lowers the operating ability of the computer system.

The variables managed by the program are referred to and rewritten many times by the program. Only the variable identical to the value obtained through the operation the program has performed is transferred to the peripheral control unit. Hence, in the system wherein variable that can be used by the peripheral control unit is accessed only while the cache control remains prohibited, the memory is accessed so many times that the operating ability of the system is lowered.

In view of this, a novel technique should be developed, which can select cache control or cache non-control for the same variable stored in a memory, without accessing a cache control register.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary block diagram showing the configuration of an information processing apparatus according to an embodiment of the invention;

FIG. 2 is an exemplary diagram explaining two variable spaces that are used in the information processing apparatus according to the embodiment;

FIG. 3 is an exemplary diagram explaining how data is rewritten in the cache-off mode and in the cache-on mode in the information processing apparatus according to the embodiment;

FIG. 4 is an exemplary diagram showing an on/off control table that may be used in the information processing apparatus according to the embodiment;

FIG. 5 is an exemplary block diagram explaining how access is made to the cache provided in the information processing apparatus according to the embodiment;

FIG. 6 is an exemplary flowchart explaining the sequence of a read/write access process performed by the cache controller incorporated in the information processing apparatus according to the embodiment; and

FIG. 7 is an exemplary flowchart explaining the sequence of a code reduction process that is applied to the information processing apparatus according to the embodiment.

### DETAILED DESCRIPTION

Various embodiments according to the invention will be described hereinafter with reference to the accompanying drawings. In general, according to one embodiment of the invention, an information processing apparatus includes a processor, a cache, and a cache controller. The processor is configured to output a memory access request for accessing an entity of a variable stored in a variable-storage region provided in a memory by using first or second memory address. Both the first and second memory addresses are allocated to the variable-storage region. The cache is configured to store some of data items stored in the memory. The cache controller is configured to access the memory or the cache by using a memory address designating the variable-storage region, in accordance with one of the first and second memory addresses which is included in a memory access request coming from the processor. For example, when a memory address included in the memory access request is the first memory address, the cache controller accesses the memory. When the memory address included in the memory access request is the second memory address, the cache controller accesses the cache.

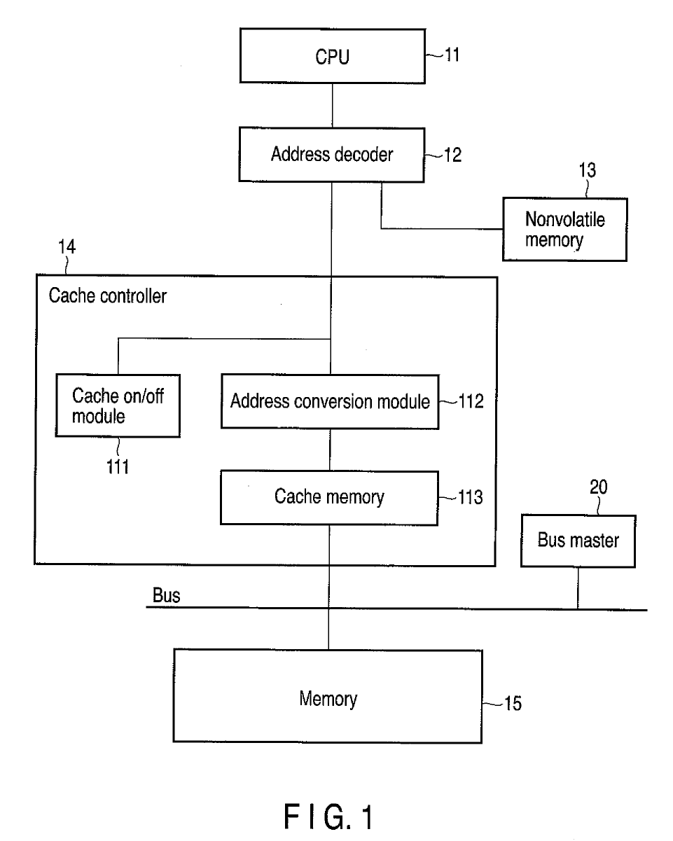

At first, the configuration of an information processing apparatus according to the embodiment of this invention will be described with reference to FIG. 1. The information processing apparatus is used as computer, personal digital assistants (PDA) or an embedded system for various electronic devices. The embedded system is a computer system to be incorporated in electronic devices (e.g., hard disk drive).

The information processing apparatus comprises a CPU 12, an address decoder 12, and a cache controller 14.

The CPU 11 is a processor that executes various programs. The CPU 11 performs various operations and controls the other various devices provided in the information processing apparatus. The CPU 11 has a memory space (i.e., memory address space). In the memory space, a nonvolatile memory 13 and a memory 15 are mapped. The CPU 11 can make access to the nonvolatile memory 13 and memory 15.

When the information processing apparatus is booted, the CPU 11 loads the programs stored in the nonvolatile memory 13 into the memory 15 and executes the program. The nonvolatile memory 13 is a nonvolatile storage device such as flash EEPROM or ROM.

The memory 15 has variable storage region for storing the values (entities) of variables that are managed by programs. In the information processing apparatus, access can be made to the variable storage region of the memory 15 by using either of two different memory addresses, i.e., first and second memory addresses. That is, the CPU 11 outputs a memory access request for accessing an entity of a variable stored in a variable-storage region provided in a memory by using first or second memory address. Both the first and second memory addresses are allocated to the variable-storage region.

The address decoder 12 decodes the memory address included in the memory access request output from the CPU 11. In accordance with the memory address decoded, the address decoder 12 selects the nonvolatile memory 13 or the memory 15 as memory that should be accessed.

The cache controller 14 is provided between, and is connected to, the CPU 11 and the memory 15. The cache controller 14 has the function of automatically switching the cache control on or off (enable/disable) in accordance with the memory address included in the memory access request. That is, the cache controller 14 is configured to access the memory 14 or the cache 113 by using a memory address designating the variable-storage region, in accordance with one of the first and second memory addresses which is included in a memory access request coming from the CPU 11.

The cache controller 14 can be integrated with the CPU 11, forming, for example, a single-chip microcomputer such as a system-on-a-chip (SOC). The single-chip microcomputer works as the core unit of the information processing apparatus according to this embodiment.

The memory address included in the memory access request coming from the CPU 11 may be the first memory address. In this case, the cache controller 14 determines that a non-cacheable region should be accessed. The cache controller 14 then stops the cache control, and uses a memory address designating a variable storage region, making access to the memory 15.

On the other hand, the memory address included in the memory access request coming from the CPU 11 may be the second memory address. In this case, the cache controller 14 determines that a cacheable region should be accessed. The cache controller 14 performs cache control, making access to the cache. The cache controller 14 then uses the memory address designating the variable storage region, making access to the cache.

The memory 15 is an external memory device provided to store programs executed by the CPU 11. (These programs include groups of instructions, and groups of variables, i.e., data items.) The memory 15 is, for example, a dynamic RAM. The memory 15 is used as main memory. The memory 15 is connected to the cache controller 14 by a bus. A bus master 20 is provided on the bus, and can access the memory 15.

The program loaded in the memory 15 contains code that is used to access a variable (entity) stored in a variable storage region, by using either the first memory address or the second memory address. The CPU 11 executes the program held in the memory 15, and outputs a memory access request for an access to the value (entity) of a variable stored in the variable storage region.

The nonvolatile memory 13, memory 15 and bus master 20 and the like are added to the configuration including the CPU 11 and the cache controller 14, constituting a system. This system works as an information processing system according to the present embodiment.

The cache controller 14 comprises a cache on/off control module 111, an address conversion module 112, and a cache (cache memory) 113. The cache (cache memory) 113 stores some of the data items held in the memory 15.

The cache on/off control module 111 receives a memory address designated by the memory access request from the CPU 11 and decodes the memory address. From the results of decoding the memory address, the cache on/off control module 111 determines whether the memory access request is a access request for a non-cacheable region or a access request for a cacheable region. That is, the cache on/off control module 111 determines which memory region the memory access request designates, a non-cacheable region or a cacheable region. As mentioned above, two memory addresses (i.e., first memory address and second memory address) are allocated to the variable storage region for holding a variable (entity). If the memory access request coming from the CPU 11 designates the first memory address, the cache on/off control module 111 determines that a non-cacheable region should be accessed and, therefore, stops the cache control. In this case, the read/write access is made to the memory 15 in response to the memory access request. On the other hand, the memory access request coming from the CPU 11 may designate the second memory address. Then, the cache on/off control module 111 determines that a cacheable region should be accessed and, therefore, performs the cache control. In this case, the read/write access is made to the cache memory 113 in response to the memory access request.

The address conversion module 112 can convert the first and second memory addresses to proper memory address that specifies variable storage region, respectively. Assume that one of the first and second memory addresses specifies the proper memory address of a variable storage region, and that the other memory address specifies an address different from the proper memory address of the variable storage region. Then, the address conversion module 112 may convert only the other of the first and second memory addresses.

Each of the cache memory 113 and the memory 15 is accessed, by using a memory address generated by the address conversion module 112. In other words, they are accessed, each by a proper memory address that corresponds to a variable storage region.

Thus, the cache control for accessing any variable can be automatically switched from one mode to the other, merely by switching the memory address used to access the value (data) of a variable stored in the memory 15, from the first memory address to the second memory address, or vice versa.

Hence, the cache on/off control can be efficiently accomplished for the same variable stored in the memory 15, without the necessity of accessing a cache control register. If the second memory address is used, a variable held in the memory 15 can be accessed while the cache control remains on (in cache-on mode). Therefore, if an operation is repeatedly performed on a variable held in the memory 15, the variable is accessed by using the second memory address, successfully completing the memory access cycle of the CPU 11 in zero-wait fashion. This can prevent a decrease of processing ability, which may result from the latency for accessing the memory 15.

If the first memory address is used, a variable held in the memory 15 can be accessed while the cache control remains off (in cache-off mode). Therefore, a read/write process is performed on the variable held in the memory 15. This prevents the variable held in the cache memory 113 and the variable held in the memory 15 from differing from each other. Thus, if the bus master 20 is likely to access a variable stored in the memory 15, the first memory address may be used to access to the variable. This avoids any problem that would arise if the variables held in the cache memory 113 and memory 15, respectively, should differ from each other.

In the cache-off mode, the read/write process may be performed on the memory 15 only, not via the cache memory 113. Nevertheless, the read/write process may be performed on both the cache memory 113 and the memory 15. If this is the case, the write policy of the cache memory 113 is set to write-through scheme, and the read/write access is made while the read cache remains off. That is, the read/write process is performed in the cache-off mode in which a write access of write-through scheme is allowed and the data reading from the cache memory 113 is prohibited, in order to preserve the cache coherence.

Even if a variable is accessed in the cache-off mode by using the first memory address, the read data read from the memory 15 and the write data from the CPU 11 are stored in the cache memory 113. A cache-hit is therefore achieved when the second memory address is then used to make read/write access to the variable. When cache-hit is achieved, the read/write accessing can be completed immediately.

<Cache Control Architecture>

The cache control architecture used in this embodiment will be described in detail.

When a program makes access to an external variable, whether the variable should be cached or not is determined, usually by one of the following two alternative methods:

(1) Whether the variable should be cached is determined in accordance with whether the storage region holding the variable is set in a cacheable region or a non-cacheable region.

(2) Whether the variable should be cached is determined by setting the cache control register.

In the first method (1), access mode for the same variable can not be dynamically switched between a cache-on mode and a cache-off mode. In the second method (2), to change the access mode for the same variable between the cache-on mode and the cache-off mode, access must be made to the cache control register. This access to the cache control register slows down the process slows down and makes the program code long.

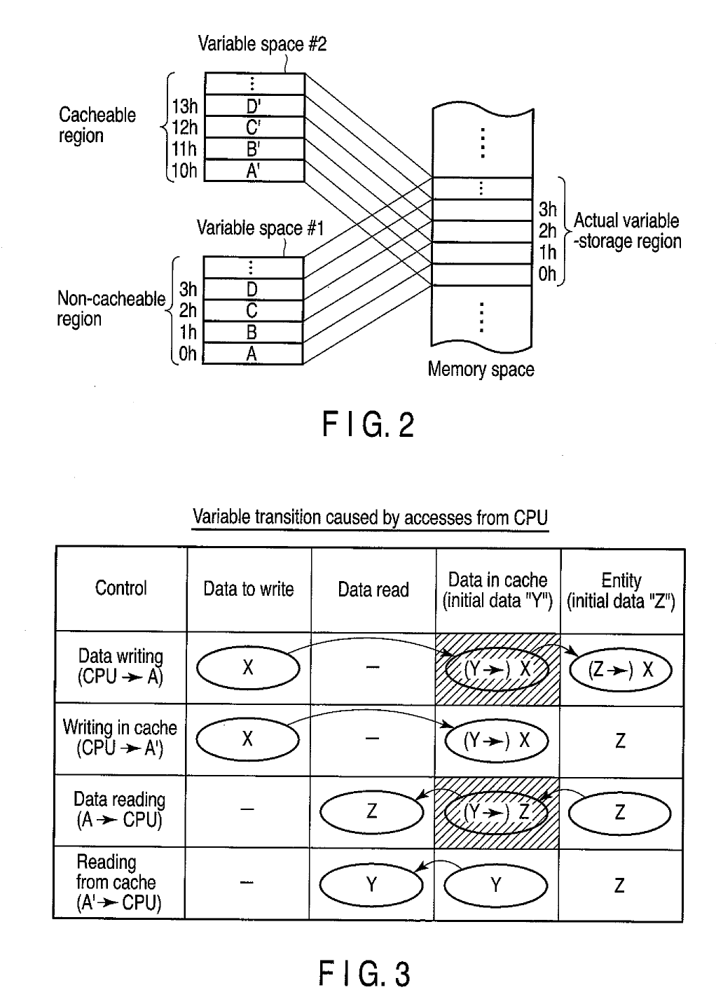

As shown in FIG. 2, the present embodiment has two variable spaces, which are allocated to the memory space the CPU 11 can access. One variable space #1 is used to make access to any variable held in the memory 15 in the cache-off mode. The other variable space #2 is used to make access to any variable held in the memory 15 in the cache-on mode.

In the configuration of FIG. 2, the memory regions corresponding to memory addresses 0h, 1h, 2h, 3h, . . . and provided in the memory 15 are utilized as variable data memory regions for holding the values (entities) of respective variables. The variable data storage regions includes variable storage regions to which memory addresses 0h, 1h, 2h, 3h, . . . are allocated. Each variable storage region stores the entity (data) of a variable corresponding to the variable storage region.

Assume that four variables A, B, C and D are available. The entity of variable A is stored in the variable storage region of memory address 0h, the entity of variable B is stored in the variable storage region of memory address 1h, the entity of variable C is stored in the variable storage region of memory address 2h, and the entity of variable D is stored in the variable storage region of memory address 3h.

The entity of each variable, or each variable storage region, is referred to, using two variable names described in the program. Here, it is assumed that two variable names A and A′ are assigned to memory address 0h; two variable names B and B′ are assigned to memory address 1h; two variable names C and C′ are assigned to memory address 2h; and two variable names D and D′ are assigned to memory address 3h.

Variable names A, B, C and D are used to access the entities of the variables corresponding to them, in the cache-off mode. The Variable names A′, B′, C′ and D′ are used to access the entities of the variables corresponding to them, in the cache-on mode.

The variable space #1 is a variable space that enables the variable data memory region to function as a non-cacheable region. The variable space #1 has, for example, memory addresses 0h, 1h, 2h, 3h, . . . that correspond to variable names A, B, C and D, respectively.

The variable space #2 is a variable space that enables the variable data memory region to function as a cacheable region. The variable space #2 has, for example, memory addresses 10h, 11h, 12h, 13h, . . . that correspond to variable names A′, B′, C′ and D′, respectively.

The program can access the variable data memory regions provided in the memory 15, no matter which variable space is used, space #1 or Space #2. In other words, the program can access the same variable in the memory 15 (i.e., the variable storage region of memory address 0h), whichever variable name, A or A′, is utilized. Similarly, the program can access the same variable in the memory 15 (i.e., the variable storage region of memory address 1h), whichever variable name, B or B′, is utilized.

To make access to, for example, the variable storage region of memory address 0h (held in the memory 15) in the cache-on mode (that is, to perform a write-back process and a read cache-on process), it is sufficient to make read/write access to memory address 10h that corresponds to variable A′. To make access to the variable storage region of memory address 0h in the cache-off mode (that is, to perform a write-through process and a read cache-off process), it is sufficient to make read/write access to memory address 0h that corresponds to variable A.

On receiving from the CPU 11 a memory access request for memory address 0h, the cache controller 14 shown in FIG. 1 makes read/write access to memory address 0h in the cache-off mode. The cache controller 14 may receive from the CPU 11 a memory access request for memory address 10h. In this case, the cache controller 14 makes read/write access to memory address 0h in the cache-on mode.

FIG. 3 is a diagram explaining how data is updated in the cache-off mode (access made to variable A) and in the cache-on mode (access made to variable A′).

In FIG. 3, X denotes the write data output from the CPU 11, Y designates the initial value of data held in the cache memory 113, and Z indicates the initial value of data held in a variable storage region provided in the memory 15.

To write data to variable A, the CPU 11 performs a memory write cycle involving memory address 0h. In the memory write cycle, the cache controller 14 writes write data X not only in the cache memory 113, but also in the variable (entity) storage region of memory address 0h provided in the memory 15.

To write data to variable A′, the CPU 11 performs a memory write cycle involving memory address 10h. In this memory write cycle, the cache controller 14 writes write data X in the cache memory 113 only.

To read variable A, the CPU 11 performs a memory read cycle involving memory address 0h. In the memory read cycle, the cache controller 14 reads data Z from the variable (entity) storage region of memory address 0h. The read data Z is not only stored in the cache memory 113, but also supplied to the CPU 11.

To read variable A′, the CPU 11 performs a memory read cycle involving memory address 10h. In this memory read cycle, the cache controller 14 uses memory address 0h, making read access to the cache memory 113. Data Y is thereby read from the cache line corresponding to memory address 0h and provided in the cache memory 113. The read data Y is supplied to the CPU 11. If a cache miss occurs, the data Z is read from the variable (entity) storage region of memory address 0h. The read data Z is not only stored in the cache memory 113, but also supplied to the CPU 11.

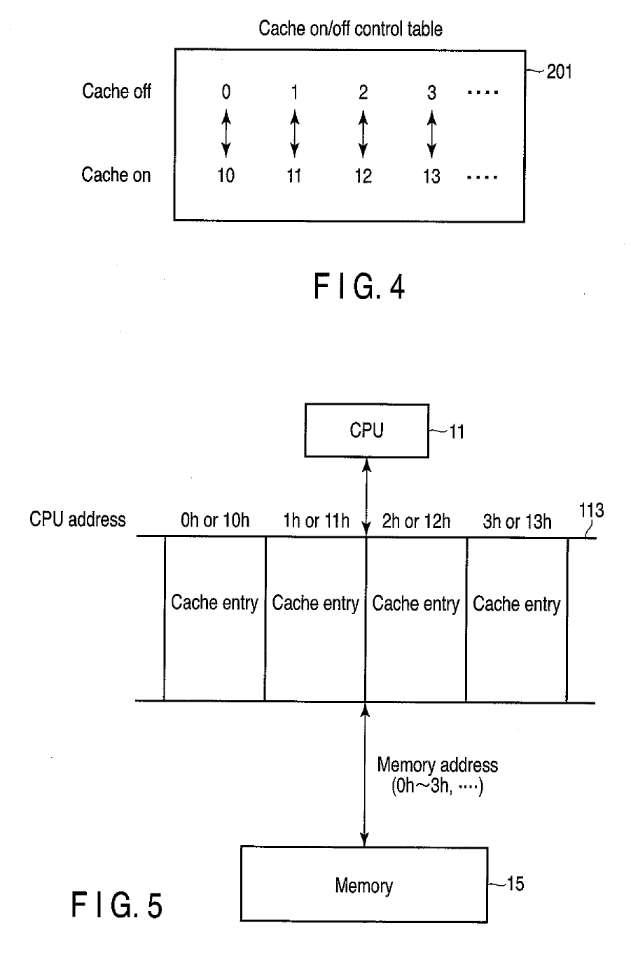

FIG. 4 shows a cache on/off control table 201 that may be referred to by the cache on/off control module 111 incorporated in the cache controller 14.

The on/off control table 201 is provided in, for example, the cache on/off control module 111. The on/off control table 201 holds memory address values 0h, 1h, 2h, 3h, . . . and memory address values 10h, 11h, 12h, 13h, . . . . Memory address values 0h, 1h, 2h, 3h, . . . belong to the non-cacheable region (i.e. variable space #1). Memory address values 10h, 11h, 12h, 13h, . . . belong to the cacheable region (i.e. variable space #2). The cache on/off control module 111 refers to the on/off control table 201, determining whether the memory access request coming from the CPU 11 request for the non-cacheable region or the cacheable region.

FIG. 5 explains how access is made to the cache memory 113.

In this embodiment, the access is made to the cache memory 113 by using a memory address the address conversion module 112 has converted. That is, whichever variable space, space #1 or space #2, is used, outputting the memory access request, the cache memory 113 is accessed by using the same memory address (i.e., address designating the variable storage region).

For example, the memory access request coming from the CPU 11 may designate variable A (memory address 0h) or variable A′ (memory address 10h). No matter whether the request designates variable A (memory address 0h) or variable Al (memory address 10h), the same memory address, e.g., address 0h, is used, making access to the cache memory 113. This increases the probability of cache-hit. Because, even if variable A′ (memory address 10h) is used, performing read/write access by using variable A′ in the cache-on mode after read/write access process has been performed by using variable A (memory address 0h), a cache-hit is achieved.

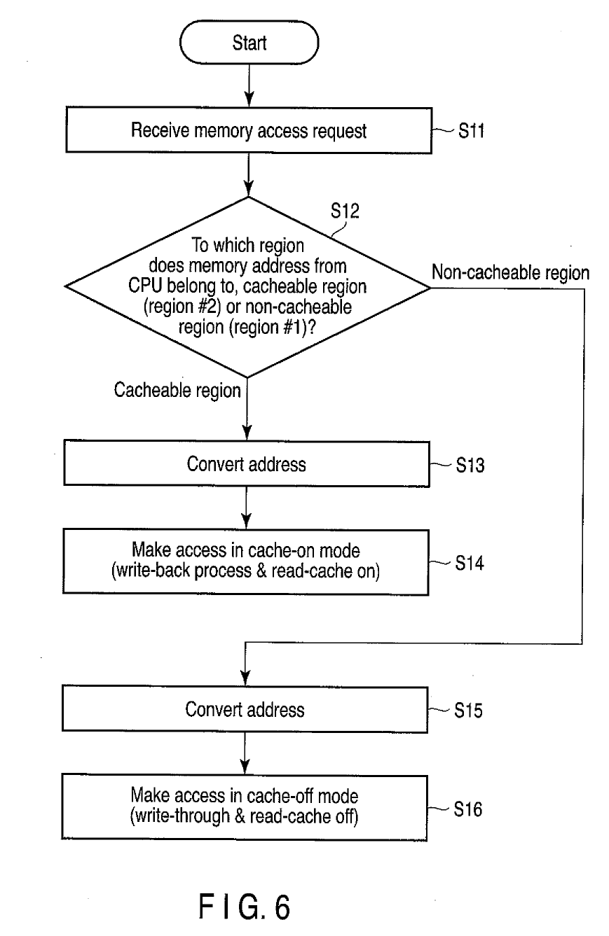

The sequence of a read/write access control the cache controller 14 performs will be explained, with reference to the flowchart of FIG. 6.

The cache controller 14 receives the memory access request output from the CPU 11 (Step S11). The cache controller 14 determines whether the memory address included in the received memory access request belongs to the cache region (space #2) or the non-cacheable region (space #1) (Step S12).

If the memory address included in the memory access request belong to the cacheable region (space #2), that is, if the memory address is the above-mentioned second memory address, the cache controller 14 converts this memory address to a memory address that corresponds to the variable storage region provided in the memory 15 (Step S13). The memory address included in the memory access request may be memory address 10h that corresponds to variable A′. In this case, memory address 10h is converted to memory address 0h that designates the variable-storage region that stores the entity of variable A′. The cache controller 14 starts controlling the cache memory 113, performing the read/write access process in the cache-on mode (Step S14). (That is, the cache controller 14 performs a write-back process and a read cache-on process).

In Step S14, if the memory access request is a memory read request, the cache controller 14 determines whether data corresponding to the memory address converted (e.g., address 0h) exits in the cache memory 113. If such data exists in the cache memory 113 (that is, if a cache-hit is achieved), the cache controller 14 read the data corresponding to memory address 0h from the cache memory 113 and supplies this data to the CPU 11. If such data does not exist in the cache memory 113 (that is, if a cache-miss occurs), the cache controller 14 uses memory address 0h, reading data from the memory 15, and not only stores the read data in the cache memory 113, but also supplies the read data to the CPU 11. The memory access request may be a memory write request. In this case, the cache controller 14 stores the write data coming from the CPU 11, in the cache line provided in the cache memory 113 and corresponding to the converted memory address, i.e., address 0h.

The memory address included in the memory access request may belong to the non-cacheable region (i.e., variable space #1), that is, the memory address is the above-mentioned first memory address. In this case, the cache controller 14 converts, if necessary, the memory address included in the memory access request to a memory address that corresponds to the variable storage region of the memory 15 (Step S15). If the memory address identical to the memory address of the variable-storage region provided in the memory 15 is used as the memory address of the variable space #1, the address conversion in Step S15 need not be performed.

In the configuration of FIG. 2, the memory address identical to the memory address of the variable storage region provided in the memory 15 is used as the memory address of the variable space #1, and the memory address different from the memory address of the variable storage region is used as the memory address of the variable space #2. Conversely, the memory address identical to the memory address of the variable storage region provided in the memory 15 is used as the memory address of the variable space #2, and the memory address different from the memory address of the variable storage region is used as the memory address of the variable space #1. If this is the case, the address conversion in Step S13 need not be performed.

Next, the cache controller 14 stops controlling the cache memory 113 in order to preserve the cache coherence, and perform the read/write access process in the cache-off mode (i.e., a write-through process and a read cache-off process) (Step S16).

In Step S16, the cache controller 14 uses memory address 0h, reading data from the memory 15, if the memory access request is requesting for the memory read at memory address 0h. The data read from the memory 15 is not only stored in the cache memory 113, but also supplied to the CPU 11. If the memory access request is requesting for the memory write at memory address 0h, the cache controller 14 stores the write data coming from the CPU 11, in the cache line provided in the cache memory 113 and corresponding to memory address 0h. Further, the cache controller 14 uses memory address 0h, making write access to the memory 15.

<Compile Method for the Cache Control>

The cache control architecture described above can turn on and off the cache control for the same variable, without the necessity of accessing the cache control register. However, the conventional compiler may not perform the optimization method achieved by compiling, because two different memory addresses are allocated to the entity of the same variable held in the memory 15.

The optimization method is a method of first extracting portions, where values of variables are uniquely determined, from the source program, and then deleting any branches where no processes pass from the source program. The compiling-optimization method severs to increase the speed of data processing and reduce the amount of code processed. Therefore, the method should be used as much as possible.

In this embodiment, the compiler for generating execution program that should be executed in the information processing apparatus of FIG. 1 has an optimization function of applying the optimization method to the cache control architecture of the information processing apparatus of FIG. 1. A program (i.e., source program) executed in the information processing apparatus of FIG. 1 is so described to access the entity of one variable held in the memory, by using the names (e.g., A and A′) of the first and second variables to which the first and second memory addresses are allocated, respectively.

The optimization function of the compiler includes the following steps:

(1) The compiler inputs information describing a pair of memory addresses, i.e., non-cacheable memory address (e.g., memory address 0h of variable A) and cacheable memory address (e.g., memory address 10h of variable A′), and recognizes the two memory addresses (i.e., memory addresses 0h and 10h) allocated to the entity of the same variable.

(2) The compiler detect, from the source program, code for instructing execution of a write-access to the non-cacheable region (e.g., code for performing write-access to the memory address 0h of variable A). When the code for instructing execution of the write-access to the non-cacheable region is detected, the compiler saves the value to be written by the code and then perform the optimization process.

(3) The compiler detect, from the source program, code for instructing execution of a read-access to the non-cacheable region (e.g., code for performing read-access to the memory address 0h of variable A). When the code for instructing execution of the read-access to the non-cacheable region is detected, the compiler saves the value to be read and then perform the optimization process.

(4) The compiler performs the optimization process in normal way if it detects, from the source program, code for instructing execution of a write-access to the cacheable region (e.g., code for performing write-access to the memory address 10h of variable A′).

(5) The compiler detect, from the source program, code for instructing execution of the read-access to the cacheable region (e.g., code for performing read-access to the memory address 10h of variable A′). When the code for instructing execution of the read-access to the cacheable region is detected, the compiler first replaces the value to be read from the cacheable region, with the value saved in the step 2 or 3, and then performs the optimization process. The value (data) stored in the cache memory 113 is overwritten by the write data or read data of the non-cacheable access as indicated by hatching in FIG. 3. Therefore, the value, that is read from the cache by the code for performing read-access to the cacheable region, must be recognized as the value (i.e., value saved in steps 2 and 3) obtained by the overwriting, in order to correctly perform the optimization process. The replace process allows the optimization process to be correctly performed.

That is, the compiler according to this embodiment analyzes the program (source program). The source program accesses the entity of one variable held in the memory 15 by selectively using the first and second variable names (A and A′) to which the first and second memory addresses (0h and 10h) are allocated.

The compiler detects, from the program, first-type code for instructing execution of read/write access to the first memory address (0h) and second-type code for instructing execution of read/write access to the first memory address (10h).

On detecting the second-type code, the compiler replaces the value to be read by the code detected, with a value to be read or written by the last first-type code, on the condition that the code detected is code for reading data and that the last of the first- and second-type code that precedes the code detected is first-type code. In other words, the value is so replaced if the last to appear of two pieces of code is code for performing read/write access to the first memory address (0h), the first-mentioned code being one for performing read/write access to the first memory address (0h), the second-mentioned code being one for performing read/write access to the second memory address (10h), and the first-mentioned code and second-mentioned code appearing before the code for performing read access to the second memory address (10h).

In the present embodiment, variable A corresponding to the cache-off mode and variable A′ corresponding to the cache-on mode exit in different spaces. Variables A and A′ are therefore independent to the compiler. In fact, however, variables A and A′ are related to each other, and are therefore held in the same variable-storage region provided in the memory space. Thus, in this embodiment, the value of variable A′ is overwritten with the value of variable A when the memory is accessed by using the memory address corresponding to variable A after the memory has been accessed by using the memory address corresponding to variable A′. By virtue of the value replacing described above, the compiler can correctly perform the optimization process, taking the above-mentioned data overwriting into account.

Assume that such C-language program is available, which is specified below:

### PROGRAM EXAMPLE 1

A′=3;

If (A′==3) {Process 1}

else {Process 2}

In Example 1, if-sentence is always true. Therefore, Process 2 is never a branch destination and can be deleted.

If A′ is a variable to be optimized, the program (codes) to be compiled can be shortened as follows:

### PROGRAM EXAMPLE 1

A′=3;

Process 1

The compiler according to the present embodiment can perform the optimization process on a program such as Program Example 2, which is specified below:

### PROGRAM EXAMPLE 2

A′=3;

A=4;

else (A′==3) {Process 3}

In the conventional optimization process, variable A′ cannot be recognized to be changed to 4 by using code “A=4.” Inevitably, a wrong optimization process is performed. A wrong program may be generated, as in Program Example 2′ specified below:

### PROGRAM EXAMPLE 2′

A′=3;

A=4;

Process 3

In fact, however, code “A=4” changes Variable A′ to 4. Process 4 therefore becomes a branch destination.

The compiler according to this embodiment first recognizes 4 as the value of A′ and then performs the optimization process to delete any code that will not become a branch destination. The compiler can therefore delete Process 3. As a result, a correct program can be generated, as in Program Example 2″ specified below.

### PROGRAM EXAMPLE 2″

A′=3;

A=4;

Process 4

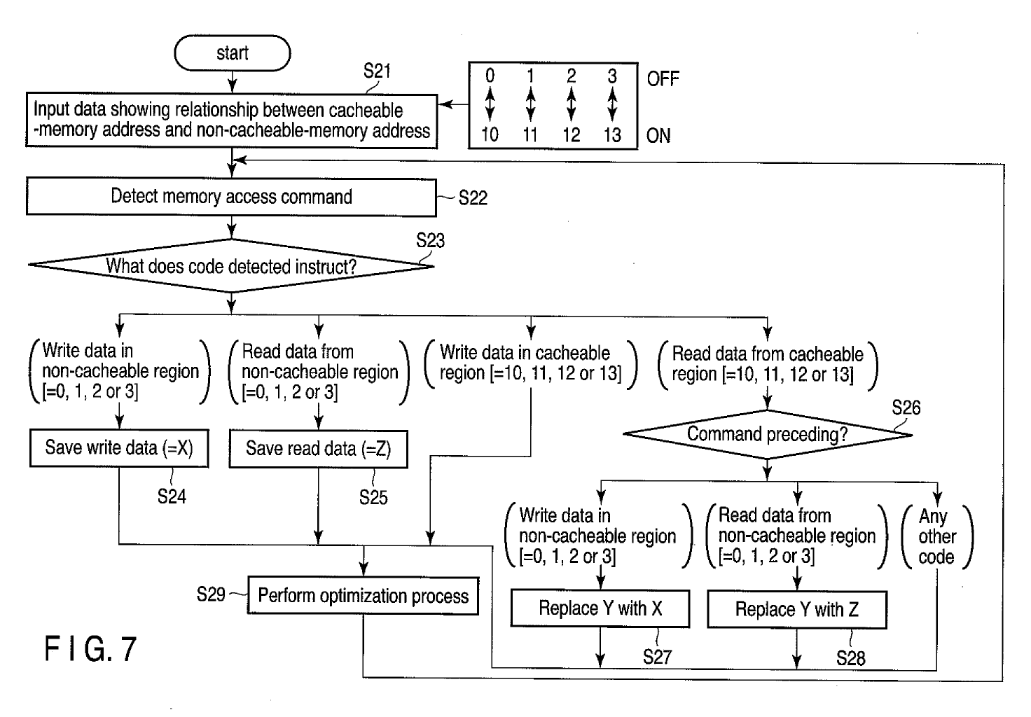

The sequence of the code reduction process that the compiler according this embodiment performs will be explained with reference to the flowchart of FIG. 7.

The compiler uses the instruction set corresponding to the CPU 11, performing compile process for converting all code included in the source program to code the CPU 11 can execute. While performing this compile process, the compiler allocates the first memory address 0h to Variable A included in the source program, and the second memory address 10h to Variable A′ included in the source program. Similarly, the compiler allocates the first memory addresses 1h, 2h and 2h to Variables B, C and D included in the source program, respectively, and the second memory addresses 11h, 12h and 13h to Variables B′, C′ and D′ included in the source program, respectively.

In the code reduction process, the compiler first inputs the information representing the relationship between the cacheable-memory address and the non-cacheable-memory address, determining which memory addresses are related to the first memory address and the second memory address, respectively (Step S21). The compiler then analyzes the program being compiled and detects, from the program, the code (command) related to the memory access (Step S22). In Step S22, the compiler detects, from the program, first-type code for instructing execution of read/write access to a non-cacheable region (i.e., 0h, 1h, 2h, or 3h), and second-type code for instructing execution of read/write access to a cacheable region (i.e., 10h, 11h, 12h, or 13h). A code that instructs writing in the non-cacheable region (i.e., 0h, 1h, 2h, or 3h) and a code that instructs data reading from the non-cacheable region (i.e., 0h, 1h, 2h, or 3h) are the first-type codes. A code that instructs data writing in the cacheable region (i.e., 10h, 11h, 12h, or 13h) and a code that instruct data reading from the cacheable region (i.e., 10h, 11h, 12h, or 13h) are the second-type codes.

Every time the compiler detects first-type or second-type code, it performs the following process.

At first, the compiler determines whether the code detected instructs data writing in the non-cacheable regions (0h, 1h, 2h, or 3h), data reading from the non-cacheable regions (0h, 1h, 2h, or 3h), data writing in the cacheable regions (10h, 11h, 12h, or 13h), or data reading from the non-cacheable regions (10h, 11h, 12h, or 13h) (Step S23).

If the code detected instructs data writing in the non-cacheable regions (0h, 1h, 2h, or 3h), the compiler saves the value X of the write data (Step S24). If the code detected instructs data reading from the non-cacheable regions (0h, 1h, 2h, or 3h), the compiler specifies the value Z of the read data to be read, and saves the value Z specified (Step S25).

The code detected may instruct data reading from the cacheable regions (10h, 11h, 12h, or 13h). In this case, the compiler performs the next process.

More precisely, if the code detected instructs data reading from, for example, the cacheable region (10h), the compiler finds a code for performing read/write access to the non-cacheable region (0h) or the cacheable region (10h) and preceding the code detected, and determines whether the found preceding code instructs data writing in the non-cacheable region (0h), data reading from the non-cacheable region (0h), or is any other code (Step S26).

If the found preceding code instructs data writing in the non-cacheable region (0h), the compiler replaces the value Y to be read from the cacheable region (10h) with the saved value X (Step S27).

If the found preceding code instructs data reading from the non-cacheable region (0h), the compiler replaces the value Y to be read from the cacheable region (10h) with the saved value Z (Step S28).

Thus, the compiler replaces value to be read from a cacheable region (10h, 11h, 12h or 13h) with the saved value. Thereafter, the compiler performs the optimization process on the basis of the new value in order to delete, from the program, any code that will not become a branch destination (Step S29).

As has been described, in the present embodiment, the cache control or the cache non-control can be selected for the same variable stored in a memory, without accessing the cache control register. Hence, data can be processed at high speed and the amount of code processed can be reduced.

Moreover, the compile method is improved, which optimizes the compiling, while utilizing the cache control architecture described above. This increases the data-processing speed and deletes more code.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a processor configured to send a memory access request for accessing an entity of a variable stored in a variable-storage region in a memory by using either a first or second memory address, both the first and second memory addresses being allocated to the variable-storage region;
a cache configured to store data items stored in the memory; and
a cache controller configured to access either the memory or the cache by using a memory address designating the variable-storage region, in accordance with either the first or second memory address in the memory access request.

2. The information processing apparatus of claim 1, wherein the cache controller is configured to access the memory when a memory address in the memory access request is the first memory address, and to access the-cache when the memory address in the memory access request is the second memory address.

3. The information processing apparatus of claim 2, wherein the cache controller is configured to read and write in a cache-off mode where write access of a write-through scheme is allowed when the memory address in the memory access request is the first memory address.

4. The information processing apparatus of claim 3, wherein the cache controller is configured to read and write in a cache-on mode where a write access of write-back scheme is allowed, when the memory address in the memory access request is the second memory address.

5. The information processing apparatus of claim 2, wherein the cache controller is configured to read and write in a cache-off mode where write access of the write-through scheme is allowed and reading data from the cache is prohibited, when the memory address in the memory access request is the first memory address.

6. The information processing apparatus of claim 5, wherein the cache controller is configured to read and write in a cache-on mode where write access of the write-back scheme is allowed and reading data from the cache is allowed, when the memory address in the memory access request is the second memory address.

7. The information processing apparatus of claim 1, wherein one of the first and second memory address is different from the memory address designating the variable-storage region, and the cache controller comprises an address convertor configured to convert the memory address in the memory access request to the memory address designating the variable-storage region, when the memory address in the memory access request is the one of the first and second memory addresses different from the memory address designating the variable-storage region.

8. The information processing apparatus of claim 1, wherein the memory is configured to store a program for accessing the entity of the variable by using the first or second memory address, and the processor is configured to execute the program.

9. An information processing system comprising:
a memory;
a nonvolatile storage device configured to store a program for accessing an entity of a variable stored in a variable-storage region in the memory by using either a first or second memory address, both the first and second memory addresses being allocated to the variable-storage region;
a processor configured to load the program into the memory and to execute the program loaded in the memory;
a cache configured to store data items stored in the memory; and
a cache controller configured to access either the memory or the cache by using a memory address designating the variable-storage region, in accordance with either the first or second memory address in a memory access request from the processor.

10. The information processing system of claim 9, wherein the cache controller is configured to determine that a memory access request from the processor is an access request for a non-cacheable region and to access the memory when a memory address in the memory access request is the first memory address, and to determine that the memory access request is an access request for a cacheable region and to access the cache when the memory address in the memory access request is the second memory address.

11. The information processing system of claim 10, wherein the cache controller is configured to read and write in a cache-off mode where write access of a write-through scheme is allowed and reading data from the cache is prohibited when the memory address comprised in the memory access request is the first memory address.

12. The information processing system of claim 11, wherein the cache controller is configured to read and write in a cache-on mode where write access of the write-back scheme is allowed and reading data from the cache is allowed when the memory address in the memory access request is the second memory address.

13. A compile method of generating a program to be executed in an information processing apparatus configured to read and write in a cache-off mode where write access of a write-through scheme is allowed and reading data from a cache is prohibited when a memory address in a memory access request from a processor is a first memory address, and to read and write in a cache-on mode where write access of the write-back scheme is allowed and reading data from the cache is allowed when the memory address in the memory access request is the second memory address, the method comprising:
detecting a first module instructing read or write access to the first memory address and a second module instructing read or write access to the second memory address from a program configured to access an entity of a variable stored in a memory by using either a first or second variable name assigned to the first or second memory address, respectively;
replacing a value to be read by the second module with a new value to be read or written by a previous module when the second module is detected, if the detected second module is for reading data and the previous module that precedes the detected second module is the first module; and
optimizing by deleting modules not to be used from the program on the basis of the new value.

14. The compile method of claim 13, wherein the replacing comprises:
saving the value read or written by the first module when the first module is detected; and
using the saved value.
